(19) United States
(12) Patent Application Publication
(10) Pub. No.: US 2025/0366387 A1
(43) Pub. Date: Dec. 4, 2025

(54) Agricultural Implements Comprising Plugging Detection Systems and Related Methods

(71) Applicant: AGCO Corporation, Duluth, GA (US)

(72) Inventors: Wade L. Stroda, Hesston, KS (US); Michael B. Bayliff, Mulvane, KS (US)

(21) Appl. No.: 19/187,678

(22) Filed: Apr. 23, 2025

Related U.S. Application Data
(60) Provisional application No. 63/653,315, filed on May 30, 2024.

(51) Int. Cl. A01B 76/00; A01B 21/08

(52) U.S. Cl. CPC A01B 76/00; A01B 21/086

(57) ABSTRACT

An agricultural implement includes a main frame having a support bar oriented in a direction generally transverse to a direction of travel when the implement is used to work a field, a plurality of rotating ground-engaging elements aligned along a length of the support bar, and a plugging detection system configured to alert an operator if one or more of the ground-engaging elements have an acceleration different from an acceleration of remaining ground-engaging elements by at least a threshold amount. The plugging detection system has an accelerometer for each of the plurality of ground-engaging elements and a control module that compares accelerometer data of each ground-engaging element to accelerometer data of the remaining ground-engaging elements. Related methods are also disclosed.

### CROSS-REFERENCE TO RELATED APPLICATIONS

This application claims the benefit of the filing date of U.S. Provisional Patent Application 63/653,315, “Agricultural Implements Comprising Plugging Detection Systems and Related Methods,” filed May 30, 2024, the entire disclosure of which is incorporated herein by reference.

### FIELD

Embodiments of the present disclosure relate generally to agricultural implements, and more particularly, to implements that have disc blades or other rotating ground-engaging elements.

### BACKGROUND

Modern farms are faced with a variety of problems, including increased concern for soil erosion, crop residue management, and rising production costs with stagnant crop prices. One way farmers are addressing these concerns is to reduce, as far as possible, the number of passes which a farmer must make over the fields. In corn growing operations, after the corn is harvested, a farmer may conduct fall tillage to bury the crop residue (e.g., stocks or stubble) from the harvested crop and to break up sub-soil compaction in preparation for spring planting. Disc harrow implements have been developed to accomplish both of these tasks in a single pass.

Disc harrows contain a set of rotating blades that cut and incorporate residue into the soil. The rotation of the blades is caused by forward travel of the implement being pulled through the field by a tractor. One typical disc harrow has a pair of wings, each having multiple gangs of disc blades, mounted on the front of the implement with the wings angled inward and rearward toward each other followed by another pair of wings having disc gangs which are angled inward and forward toward each other.

The process of moving soil and residue in various soil types and various soil conditions with a disc harrow can lead to plugging problems. This plugging typically occurs when residue gets stuck between the disc scraper and the disc blade, or when residue builds up around the disc gang connection points. Once this plugged condition occurs, the operator must take action to prevent building up a large pile of dirt and residue in front of the disc harrow. The pile of residue is undesirable as it impacts planting conditions and has the potential to reduce the lift of the disc harrow.

Agricultural planters with numerous row units are used to plant seeds upon or in the ground. Planters may have a central portion pulled by a tractor and may have wings extending from either side. The individual row units, mounted to the center section or to a wing, typically deliver seeds into separate rows. The row units may receive seed from a common central hopper. Each row unit may have ground-engaging tools to clear residue, open a seed trench, plant seeds, deliver fertilizer, close a seed trench, etc. These tools may also have plugging problems, as described above in relation to disc harrows.

### BRIEF SUMMARY

In some embodiments, an agricultural implement includes a main frame having a support bar oriented in a direction generally transverse to a direction of travel when the implement is used to work a field, a plurality of rotating ground-engaging elements aligned along a length of the support bar, and a plugging detection system configured to alert an operator if one or more of the ground-engaging elements have an acceleration different from an acceleration of remaining ground-engaging elements by at least a threshold amount. The plugging detection system has an accelerometer for each of the plurality of ground-engaging elements and a control module that compares accelerometer data of each ground-engaging element to accelerometer data of the remaining ground-engaging elements.

Each accelerometer may be in wireless communication with the control module, such as via Bluetooth or other electromagnetic communications.

In some embodiments, the support bar includes a toolbar, and the implement has a plurality of row units spaced along the toolbar. Each ground-engaging element is carried by one of the row units. The plugging detection system is configured to compare an acceleration of a ground-engaging element carried by one of the row units with an acceleration of a ground-engaging element carried by another of the row units.

The row units may planter row units, fertilizer row units, etc., and may each be coupled to the toolbar by a parallel linkage.

The toolbar may have a first section and at least one wing section hingedly coupled to the first section.

In some embodiments, the implement includes a plurality of spacer spools between adjacent disc blades configured to maintain a spacing of the disc blades along the support bar, wherein each accelerometer is within one of the spacer spools.

In some embodiments, each ground-engaging element is mounted to the support bar with a spring and a bearing, and the accelerometer for each of the plurality of ground-engaging elements is integrated with the bearing.

Some embodiments include a method for operating an agricultural implement having a plurality of rotating ground-engaging elements aligned along a length of a support bar. The method includes measuring an acceleration of each of the ground-engaging elements with accelerometers, transmitting the acceleration of each of the ground-engaging elements to a control module, comparing the accelerations of each of the ground-engaging elements using the control module, and displaying an alert if one of the ground-engaging elements has an acceleration that is different than other of the ground-engaging elements by a preselected threshold amount. The acceleration may be transmitted wirelessly from the accelerometers to the control module.

Within the scope of this disclosure, it should be understood that the various aspects, embodiments, examples, and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

### BRIEF DESCRIPTION OF THE DRAWINGS

While the specification concludes with claims particularly pointing out and distinctly claiming what are regarded as embodiments of the present disclosure, various features and advantages may be more readily ascertained from the following description of example embodiments when read in conjunction with the accompanying drawings, in which:

FIG. 1 is a simplified perspective view of an agricultural disc harrow implement;

FIG. 2 is a simplified view of a support bar and disc gangs of the implement shown in FIG. 1;

FIG. 3 is a simplified view of a portion of one of the disc gangs of the implement shown in FIG. 1;

FIG. 4 is an exploded view of a portion of one of the disc gangs of the implement shown in FIG. 1;

FIG. 5 is a simplified top view of a tractor pulling an implement;

FIG. 6 is a simplified side view of the tractor and implement shown in FIG. 5;

FIG. 7 illustrates a control module that may be used in conjunction with agricultural implements; and

FIG. 8 is a flow chart illustrating a method for operating an agricultural implement.

### DETAILED DESCRIPTION

The illustrations presented herein are not actual views of any agricultural implement or portion thereof, but are merely idealized representations to describe example embodiments of the present disclosure. Additionally, elements common between figures may retain the same numerical designation.

The following description provides specific details of embodiments. However, a person of ordinary skill in the art will understand that the embodiments of the disclosure may be practiced without employing many such specific details. Indeed, the embodiments of the disclosure may be practiced in conjunction with conventional techniques employed in the industry. In addition, the description provided below does not include all the elements that form a complete structure or assembly. Only those process acts and structures necessary to understand the embodiments of the disclosure are described in detail below. Additional conventional acts and structures may be used. The drawings accompanying the application are for illustrative purposes only, and are thus not drawn to scale.

As used herein, the terms “comprising,” “including,” “containing,” “characterized by,” and grammatical equivalents thereof are inclusive or open-ended terms that do not exclude additional, unrecited elements or method steps, but also include the more restrictive terms “consisting of” and “consisting essentially of” and grammatical equivalents thereof.

As used herein, the term “may” with respect to a material, structure, feature, or method act indicates that such is contemplated for use in implementation of an embodiment of the disclosure, and such term is used in preference to the more restrictive term “is” to avoid any implication that other, compatible materials, structures, features, and methods usable in combination therewith should or must be excluded.

As used herein, the term “configured” refers to a size, shape, material composition, and arrangement of one or more structure and/or apparatus facilitating operation thereof in a predetermined way.

As used herein, the singular forms following “a,” “an,” and “the” are intended to include the plural forms as well, unless the context clearly indicates otherwise.

As used herein, the term “and/or” includes any and all combinations of one or more of the associated listed items.

As used herein, spatially relative terms, such as “beneath,” “below,” “lower,” “bottom,” “above,” “upper,” “top,” “front,” “rear,” “left,” “right,” and the like, may be used for ease of description to describe one element's or feature's relationship to another element(s) or feature(s) as illustrated in the figures. Unless otherwise specified, the spatially relative terms are intended to encompass different orientations of the materials in addition to the orientation depicted in the figures.

As used herein, the term “substantially” in reference to a given parameter, property, or condition means and includes to a degree that one of ordinary skill in the art would understand that the given parameter, property, or condition is met with a degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

The terms “longitudinal” and “transverse” are made in relation to a machine's normal direction of travel. In other words, the term “longitudinal” equates to the fore-and-aft direction, whereas the term “transverse” equates to the crosswise direction, or left and right.

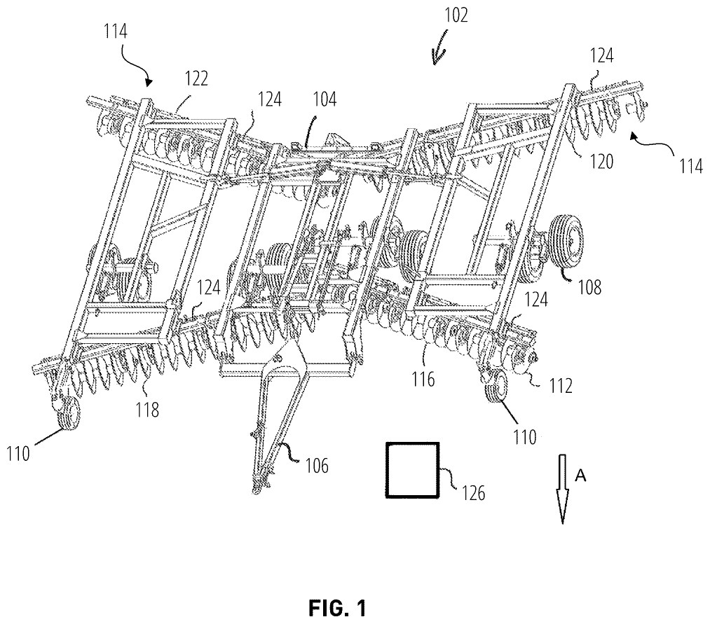

FIG. 1 illustrates an agricultural disc harrow implement 102, which is pulled by an agricultural vehicle, such as a tractor, in a direction A of travel when the implement 102 is used to work a field. The implement 102 includes a main frame 104 having a hitch 106 on the front end that may be used to connect the implement 102 to the agricultural vehicle. A set of center wheels 108 is attached across the main frame 104 at positions, for example, roughly midway between the front and rear ends of the main frame 104. The center wheels 108 support the implement 102 as well as provide depth adjustment. Additionally, a set of pivoting wheels 110 is connected to front distal ends of the main frame 104.

The implement 102 also includes a plurality of disc blades 112 mounted on one or more gang assemblies 114 attached to the main frame 104. In accordance with one example configuration illustrated in FIG. 1, the gang assemblies 114 are arranged with a front left wing 116, a front right wing 118, a rear left wing 120, and a rear right wing 122. However, one skilled in the art will understand that the one or more gang assemblies 114 on the implement 102 may be arranged in other suitable configurations. In the illustrated embodiment, the front left wing 116 and the front right wing 118 are positioned at respective converging angles that extend inward and rearward from outside to inside, and the rear left wing 120 and rear right wing 122 are positioned at respective converging angles that extend inward and forward from outside to inside. The front left wing 116 and the front right wing 118 are aligned with the rear left wing 120 and the rear right wing 122, respectively, such that the ground is engaged by the plurality of disc blades 112 as the implement 102 is pulled in the direction of motion A by the agricultural vehicle. Each wing 116, 118, 120, 122 includes a support bar 124 extending substantially the length of the wing. The support bar 124 is attached to the main frame 104. The support bar 124 is oriented in a direction generally transverse to the direction A of travel when the implement is used to work a field. For example, the support bar 124 may be angled from approximately 60° to 90° from a central longitudinal axis of the implement 102, such as approximately 75°. In some embodiments, the support bar 124 may be oriented perpendicular (i.e., 90°) to the direction A of travel.

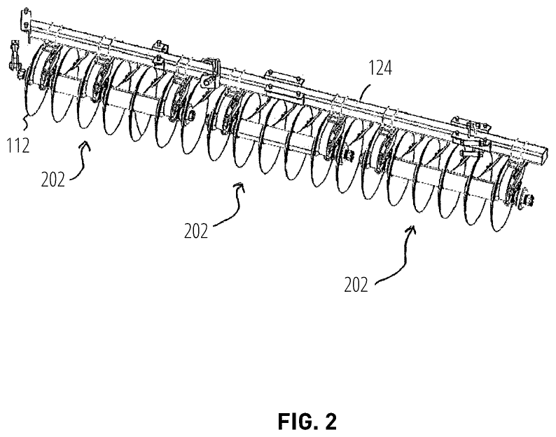

Turning also now to FIG. 2, each wing 116, 118, 120, 122 includes a plurality of disc gangs 202 aligned along the length of the support bar 124 of the wing. Each disc gang 202 has a plurality of the disc blades 112 substantially equally spaced along an axis of the disc gang 202. The wing depicted in FIG. 2 has three disc gangs 202, and each disc gang 202 mounts either 6 or 7 disc blades 112. However, one skilled in the art will understand that fewer or more disc blades 112 may be mounted on each disc gang 202 and each wing 116, 118, 120, 122 may have fewer or more disc gangs 202 than shown in FIG. 2. The disc gangs 202 of a wing 116, 118, 120, 122 are coaxially aligned to create a line of substantially equally spaced disc blades 112.

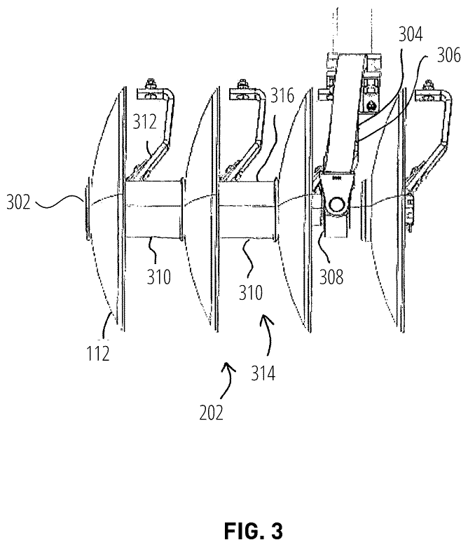

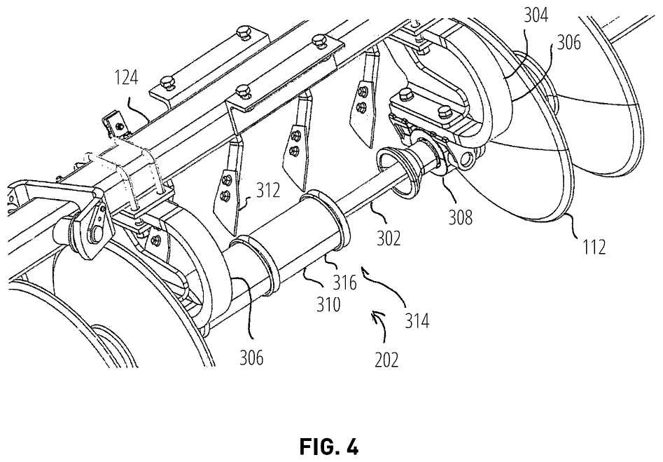

As better seen in FIG. 3 and FIG. 4, each disc gang 202 includes a rotating disc gang shaft 302, which is supported by the support bar 124 using a shaft mount 304. It is desirable that the disc blades 112 be resiliently mounted to their respective support bars 124 to prevent the disc blades 112 from being damaged or broken when striking an obstacle, such as a large rock in the field. The shaft mount 304 for the ganged disc blades 112 allows the disc blades 112 freedom to move vertically, laterally, and/or torsionally away from obstacles and hard spots to avoid damage to the disc blades 112. One suitable disc mounting mechanism is shown in U.S. Pat. RE38,974, “Agricultural Disc Mounting System and Method,” granted Feb. 14, 2006, which uses C-shaped springs 306 to mount the disc gang shaft 302 to the support bar 124. A suitable bearing 308 is mounted to a lower leg of the spring 306 to allow rotation of the gang shaft 302. However, one skilled in the art will understand that other means for mounting the disc gang shaft 302 to the support bar 124 may be contemplated using sound engineering judgment.

Spools 310 in between adjacent disc blades 112 maintain the desired spacing of the disc blades 112 along the shaft 302. Disc scrapers 312 may be attached to the support bar 124 to have an edge adjacent each disc blade 112 to keep dirt and residue from sticking to the disc blade 112.

In other embodiments, the disc blades 112 may be individually supported from the support bar 124, rather than arranged in gangs. For example, each disc blade 112 may be supported by its own shaft mount 304.

The implement 102 further includes a plugging detection system 314 configured to alert an operator if one or more of the disc gangs 202 on the implement 102 or any individual disc blades 112 are becoming plugged, thereby preventing the disc blades 112 from rotating as normal. Each disc blade 112 has an accelerometer 316 configured to measure the rotational acceleration of the disc blade 112. The plugging detection system 314 also includes a control module 126 that compares the acceleration of each disc blade 112 to the rotational speed of the other disc blades 112 on the disc gang 202 or on other disc gangs 202. If one disc gang 202 or one disc blade 112 starts to become plugged, the plugged disc gang 202 or disc blade 112 will rotate slower than the other disc gangs 202 or disc blades 112. When a complete plugged condition occurs, the plugged disc blade 112 may stop rotating completely while other disc blades 112 continue turning.

In one embodiment, the accelerometer 316 is attached to or built into one of the spools 310 along the disc gang 202. For example, the accelerometer 316 may be a wireless sensor built into the spool 310. The accelerometer 316 transmits the acceleration of the disc gang 202 to the control module 126, which can then display a plugging alert to the operator on a console or tablet in a cab of the agricultural vehicle. In an alternate embodiment, the accelerometer 316 is integrated with the bearing 308.

The accelerometer 316 may be self-powered, such that rotation of the disc blades 112 along the disc gang 202 causes the accelerometer 316 to generate electrical power to operate the accelerometer 316 and send the acceleration information to the control module 126. If the accelerometer 316 is wireless, then the risk of damage to wires during operation of the implement 102 is limited. Desirably, the accelerometer 316 may be configured to transmit only during active rotation of the disc gang 202 and to go into a hibernation mode when not in use.

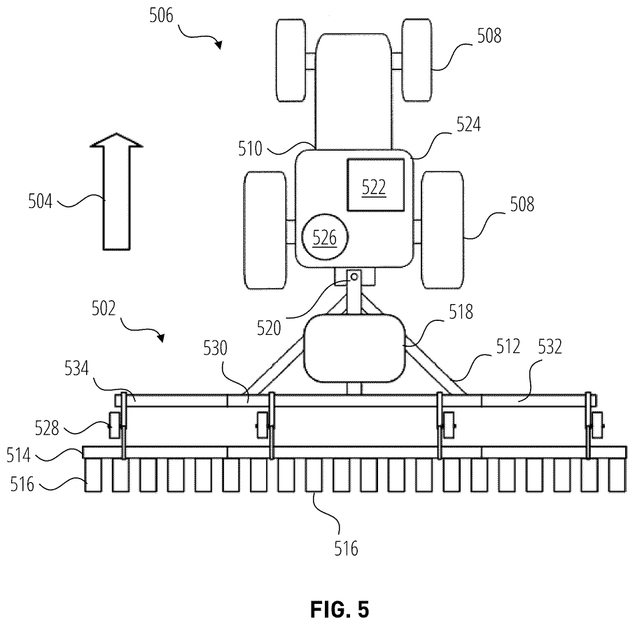

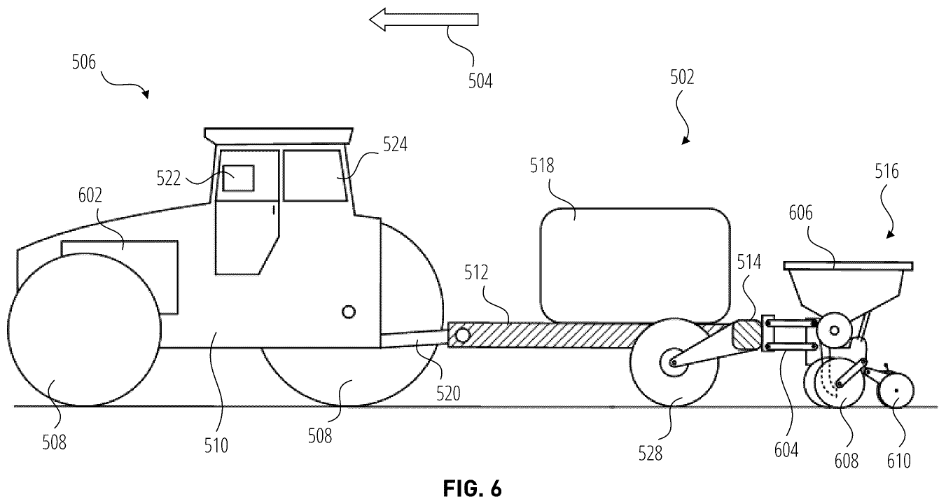

FIG. 5 illustrates a simplified top view of another agricultural implement 502 that may include a plugging detection system as described above. FIG. 6 illustrates a simplified side view of the implement 502. In use, the implement 502 is drawn in a forward direction 504 by a tractor 506. The tractor 506 has wheels 508, an engine 602, a chassis 510, and other elements as known in the art. The implement 502 has a frame 512 carrying a toolbar 514 supporting row units 516. Each row unit 516 is physically connected to the toolbar 514 by a parallel linkage 604. The row units 516 may include a mini hopper 606 fluidly connected to a central hopper 518 containing seed to be planted and/or fertilizer to be applied. That is, the row units 516 may be planter and/or fertilizer row units of any design, which are generally known in the art. The implement 502 is connected to the tractor 506 by a tow hitch 520. A computer 522, which may include a central processing unit (“CPU”), memory, implement controller, and graphical user interface (“GUI”) (e.g., a touch-screen interface), is typically located in an operator cabin 524 of the tractor 506. A global positioning system GPS receiver 526 may be mounted to the tractor 506 and connected to communicate with the computer 522. The implement controller is configured to communicate with the row units 516 and/or the GPS receiver 526, such as by wired or wireless communication.

The implement 502 may optionally be supported in the field by wheels 528 coupled to the frame 512. The frame 512 may include a first section 530 (e.g., a center section) configured to be towed by the tractor 506, and one or more wing sections 532, 534 hingedly coupled to the first section 530. For example, and as shown in FIG. 5, the first section 530 may be a center section, and two wing sections 532, 534 may be attached to opposite sides thereof. The wing sections 532, 534 may fold for transport or storage, and unfold (as shown in FIG. 5) for planting, fertilizing, or other field operations. Typically, the wheels 528 may support any or all of the wing sections 532, 534. In other embodiments, the center section 530 may be omitted, and two wing sections 532, 534 may be connected directly to one another.

Each of the row units 516 may include one or more disc blades, such as opening discs 608 and closing discs 610, though other disc blades may be present instead of or in addition to these. Row units are described, for example, in U.S. Patent Application Publication 2021/0315147 A1, “Systems Comprising Agricultural Implements Connected to Lifting Hitches and Related Control Systems and Methods,” published Oct. 14, 2021; and U.S. Patent Application Publication 2020/00396897 A1, “Fluid Control System,” published Dec. 24, 2020.

The disc blades of each row unit may include an accelerometer to detect and transmit the acceleration of each disc blade to a controller, as described above.

The acceleration as measured at disc blades may be compared to the acceleration as measured at other disc blades on other row units 516, which comparison may be used to determine whether a disc blade is plugged. If a plugged disc blade is detected, the operator can take corrective action (e.g., stopping the implement 502 and clearing the plugging, raising the plugged row unit 516, etc.).

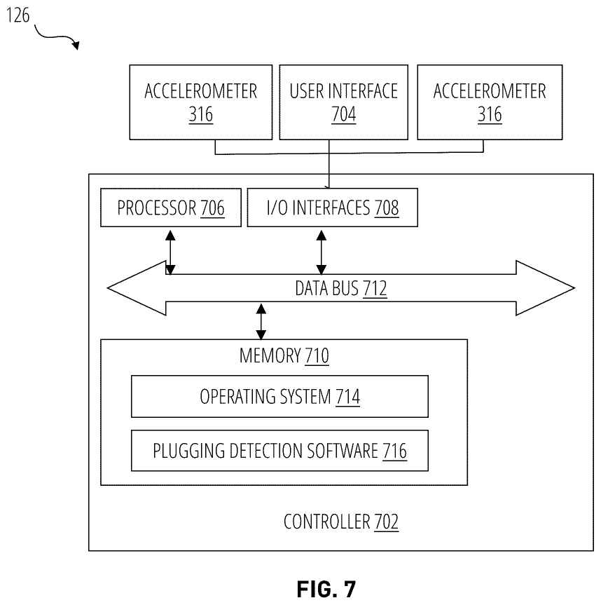

FIG. 7 shows an embodiment of an example control module 126 that may be used to control operations of the plugging detection system that may be used in the implements of FIG. 1 through FIG. 6. In one embodiment, the control module 126 includes a controller 702 (e.g., an electronic control unit or ECU) coupled to the plurality of accelerometers 316 for each of the disc blades, and a user interface 704. The example controller 702 is merely illustrative, and some controllers may have fewer or additional components, and/or some of the functionality associated with the various components depicted in FIG. 7 may be combined, or further distributed among additional modules or controllers. Further, though described in the context of residing in a single controller 702, functionality of the controller 702 may be distributed among a plurality of controllers, and in some embodiments, some of the functionality of the controller 702 may be achieved remote from the implement (e.g., if the implement has telecommunications and/or internet connectivity functionality). The controller 702 is depicted in this example as a computer system, but may be embodied as a programmable logic controller (PLC), field programmable gate array (FPGA), application specific integrated circuit (ASIC), among other devices. Certain well-known components of computer systems are omitted here to avoid obfuscating relevant features of the controller 702. In one embodiment, the controller 702 has one or more processors, such as processor 706, input/output (I/O) interfaces 708, and memory 710, all coupled to one or more data busses, such as data bus 712. The memory 710 may include any one or a combination of volatile memory elements (e.g., random-access memory RAM, such as DRAM, and SRAM, etc.) and nonvolatile memory elements (e.g., ROM, hard drive, tape, CDROM, etc.). The memory 710 may store a native operating system, one or more native applications, emulation systems, or emulated applications for any of a variety of operating systems and/or emulated hardware platforms, emulated operating systems, etc.

In the embodiment depicted in FIG. 7, the memory 710 includes an operating system 714 and plugging detection software 716. In some embodiments, additional or fewer software modules (e.g., combined functionality) may be deployed in the memory 710 or additional memory (or in different devices). In some embodiments, a separate storage device may be coupled to the data bus 712, such as a persistent memory (e.g., optical, magnetic, and/or semiconductor memory and associated drives). The storage device may be a removable device, such as a memory stick or disc.

In one embodiment, plugging detection software 716 is executed by the processor 706 to receive user input at the user interfaces 704 (e.g., one or a combination of console button, switch, knob, hydro handle or joystick, scroll wheel, display screen with selectable icon displayed on the screen that is manipulated by a mouse or joystick, display screen embodied with selectable icons on a touch-type screen, microphone on a headset or on the console, etc.), and match or associate (e.g., via look-up table or in some embodiments via programmed switch position activation) the input from the accelerometers 316.

The user interface 704 may include a display screen coupled to the controller 702 with selectable icons, a hydro handle or joystick with selectable buttons or switches, a console with switches, button, knobs, scroll wheel, a microphone, etc., with corresponding signals from operator input received at the user interfaces 704 delivered via the I/O interfaces 708 to the plugging detection software 716 executing on the processor 706. The output from the plugging detection software 716 is provided to the user interface 704, which in turn displays a warning of the plugged condition.

Execution of the plugging detection software 716 may be implemented by the processor 706 under the management and/or control of the operating system 714. For instance, the source statements that embody the method steps or algorithms of the plugging detection software 716 may be translated by one or more compilers of the operating system 714 to assembly language and then further translated to a corresponding machine code that the processor 706 executes to achieve the functionality of the plugging detection software 716. Variations of this execution process are known, depending on the programming language of the software. In some embodiments, the operating system 714 may be omitted and a more rudimentary manner of control implemented. The processor 706 may be embodied as a custom-made or commercially available processor, a central processing unit (CPU) or an auxiliary processor among several processors, a semiconductor based microprocessor (in the form of a microchip), one or more application specific integrated circuits (ASICs), a plurality of suitably configured digital logic gates, and/or other well-known electrical configurations comprising discrete elements both individually and in various combinations to coordinate the overall operation of the controller 702.

The I/O interfaces 708 provide one or more interfaces to one or more devices, such as the user interfaces 704 and the accelerometers 316, among other devices that are coupled directly or indirectly (e.g., over a bus network, such as a CAN network, including one operating according to ISOBUS standards) to the controller 702. The I/O interfaces 708 may also comprise functionality to connect to other networks. For instance, the I/O interfaces 708 may include a network interface that enables remote or wireless communications, such as via telemetry functionality, Bluetooth communications, near-field, among other electromagnetic spectrum communications.

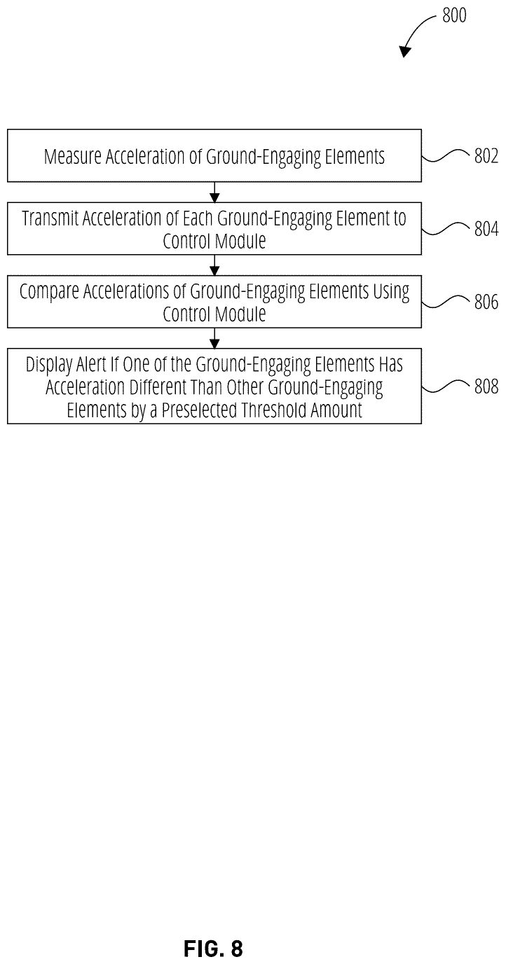

FIG. 8 is a simplified flow chart illustrating a method 800 of operating an agricultural implement, such as those described above.

In block 802, accelerometers measure accelerations of each of a plurality of ground-engaging elements aligned along the length of a support bar. In block 804, the acceleration of each of the ground-engaging elements is transmitted to a control module, such as by a wireless signal (e.g., Bluetooth communications, near-field communications, or other electromagnetic spectrum communications). In block 806, the control module compares the accelerations of each of the ground-engaging elements. In block 808, an alert is displayed if one of the ground-engaging elements has an acceleration that is different than other of the ground-engaging elements by a preselected threshold amount. The threshold amount may be selected to be an amount indicative of an operational problem of the implement, such as a plugging condition. In some embodiments, the threshold amount may be, for example, 5%, 10%, 15%, 25%, 50%, etc.

Though depicted as a flow chart, the actions in FIG. 8 may be performed concurrently, and in some embodiments, some actions may be omitted.

All references cited herein are incorporated herein in their entireties. If there is a conflict between definitions herein and in an incorporated reference, the definition herein shall control.

What is claimed is:

1. An agricultural implement comprising:
a main frame having a support bar oriented in a direction generally transverse to a direction of travel when the implement is used to work a field;
a plurality of rotating ground-engaging elements aligned along a length of the support bar; and
a plugging detection system configured to alert an operator if one or more of the ground-engaging elements have an acceleration different from an acceleration of remaining ground-engaging elements by at least a threshold amount, the plugging detection system comprising an accelerometer for each of the plurality of ground-engaging elements and a control module that compares accelerometer data of each ground-engaging element to accelerometer data of the remaining ground-engaging elements.

2. The agricultural implement of claim 1, wherein each accelerometer is in wireless communication with the control module.

3. The agricultural implement of claim 2, wherein each accelerometer is in wireless communication with the control module via Bluetooth.

4. The agricultural implement of claim 1, wherein the support bar comprises a toolbar, and further comprising a plurality of row units spaced along the toolbar.

5. The agricultural implement of claim 4, wherein each ground-engaging element is carried by one of the row units.

6. The agricultural implement of claim 5, wherein the plugging detection system is configured to compare an acceleration of a ground-engaging element carried by one of the row units with an acceleration of a ground-engaging element carried by another of the row units.

7. The agricultural implement of claim 4, wherein each row unit is coupled to the toolbar by a parallel linkage.

8. The agricultural implement of claim 4, wherein each row unit comprises a planter row unit.

9. The agricultural implement of claim 4, wherein each row unit comprises a fertilizer row unit.

10. The agricultural implement of claim 4, wherein the toolbar comprises a first section and at least one wing section hingedly coupled to the first section.

11. The agricultural implement of claim 1, further comprising a plurality of spacer spools between adjacent disc blades configured to maintain a spacing of the disc blades along the support bar, wherein each accelerometer is within one of the spacer spools.

12. The agricultural implement of claim 1, wherein each ground-engaging element is mounted to the support bar with a spring and a bearing, and wherein the accelerometer for each of the plurality of ground-engaging elements is integrated with the bearing.

13. A method for operating an agricultural implement, wherein the agricultural implement has a plurality of rotating ground-engaging elements aligned along a length of a support bar, the method comprising:
measuring an acceleration of each of the ground-engaging elements;
transmitting the acceleration of each of the ground-engaging elements to a control module;
comparing the accelerations of each of the ground-engaging elements using the control module; and
displaying an alert if one of the ground-engaging elements has an acceleration that is different than other of the ground-engaging elements by a preselected threshold amount.

14. The method of claim 13, wherein transmitting the acceleration of each of the ground-engaging elements to the control module comprises transmitting the acceleration wirelessly to the control module.
